(19) United States
(12) Patent Application Publication
(10) Pub. No.: US 2025/0344158 A1
(43) Pub. Date: Nov. 6, 2025

(54) METHODS, COMMUNICATIONS DEVICES, AND NETWORK INFRASTRUCTURE EQUIPMENT FOR MODIFYING A USER SUSTAINABILITY PROFILE

(71) Applicant: Sony Group Corporation, Tokyo (JP)

(72) Inventors: Vivek SHARMA, Surrey (GB); Yuxin WEI, Surrey (GB); Yassin Aden AWAD, Surrey (GB); Hideji WAKABAYASHI, Surrey (GB); Samuel Asangbeng ATUNGSIRI, Surrey (GB)

(73) Assignee: Sony Group Corporation, Tokyo (JP)

(21) Appl. No.: 18/879,816

(22) PCT Filed: Jul. 6, 2023
(86) PCT No.: PCT/EP2023/068718

§ 371 Date: Dec. 30, 2024

(30) Foreign Application Priority Data
Jul. 13, 2022 (EP) 22184765.0

(51) Int. Cl. H04W 52/02; H04W 68/02; H04W 76/19; H04W 76/20

(52) U.S. Cl. CPC H04W 52/0261; H04W 52/0229; H04W 68/02; H04W 76/19; H04W 76/20

(57) ABSTRACT

Methods, apparatus and circuitry for modifying and requesting modifications to a sustainability profiles for a communication device. The sustainability profile includes radio resource control parameters to be implemented by the communications device for communication with an infrastructure equipment of a wireless communication network. A communications device may request a modification to an existing sustainability profile, which may be accepted or rejected by the network. The network may also determine that the sustainability profile should be modified without the communications device requesting such a modification.

The present application claims the Paris Convention priority of European patent application EP22184765.0, filed 13 Jul. 2022, the contents of which are hereby incorporated by reference.

### BACKGROUND

### Field of Disclosure

The present disclosure relates to a communications device, network infrastructure equipment, a core network part, and an application server, circuitry therefore, and methods of operating a communications device, network infrastructure equipment, a core network part, and an application server in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is eXtended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

New and future services and wireless communications systems are also becoming increasingly focussed on meeting or contributing to sustainability considerations. The increasing use of different types of network infrastructure equipment and terminal devices associated with different traffic profiles, particularly in view of such sustainability considerations, give rise to new challenges for efficiently and sustainably handling communications in wireless communications systems that need to be addressed.

### SUMMARY OF THE DISCLOSURE

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents aspects of a conventional handover procedure;

FIG. 5 shows a message flow diagram representation of a wireless communications system comprising a communications device and a plurality of infrastructure equipment, in accordance with embodiments of the present technique,

FIG. 6 shows a message flow diagram representation of a wireless communications system comprising a communications device and a plurality of infrastructure equipment, in accordance with embodiments of the present technique.

FIG. 7 shows a message flow diagram representation of a wireless communications system comprising a communications device and a plurality of infrastructure equipment, in accordance with embodiments of the present technique.

FIG. 8 illustrates a flow diagram of a method of operating a communications device according to an example of the present disclosure.

FIG. 9 illustrates a flow diagram of a method of operating a communications device according to an example of the present disclosure.

FIG. 10 illustrates a flow diagram of a method of operating an infrastructure equipment according to an example of the present disclosure.

FIG. 11 illustrates a flow diagram of a method of operating an infrastructure equipment according to an example of the present disclosure.

FIG. 12 illustrates a flow diagram of a method of operating a core network part according to an example of the present disclosure.

FIG. 13 illustrates a flow diagram of a method of operating a core network part according to an example of the present disclosure.

FIG. 14 illustrates a flow diagram of a method of operating an application server according to an example of the present disclosure.

FIG. 15 illustrates a flow diagram of a method of operating an application server according to an example of the present disclosure.

### DETAILED DESCRIPTION OF THE EMBODIMENTS

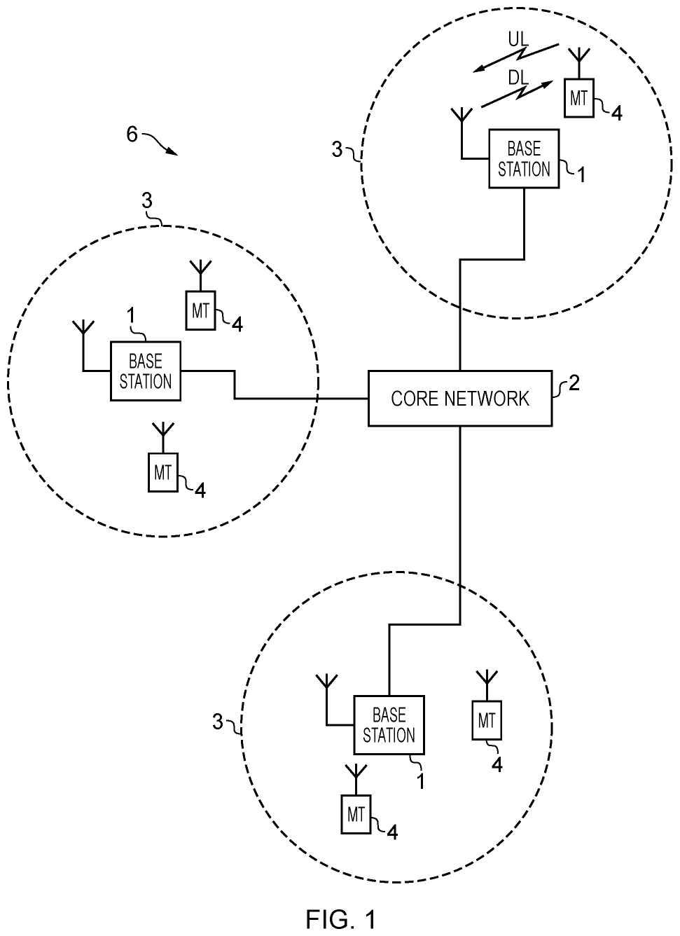

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1−10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

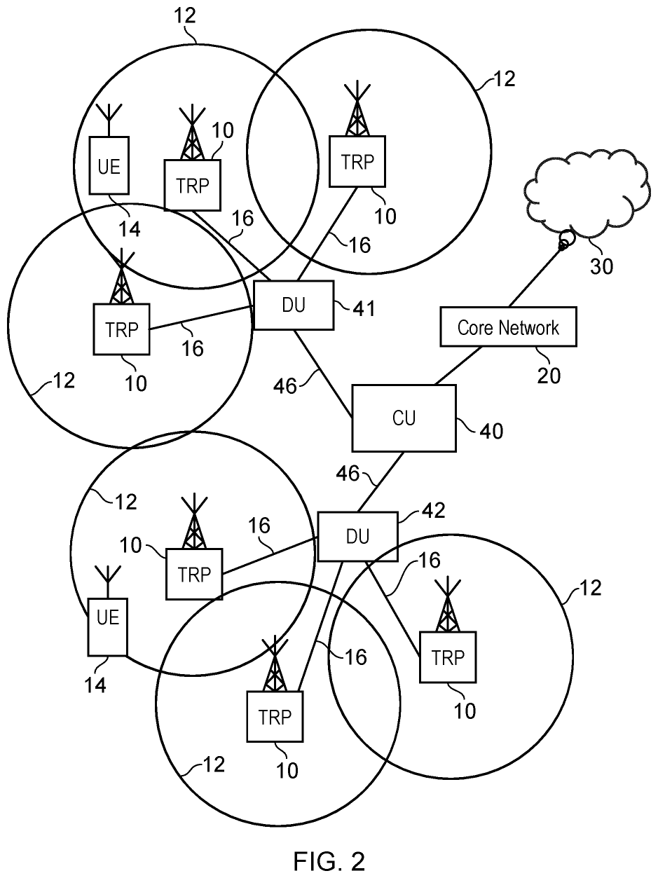

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

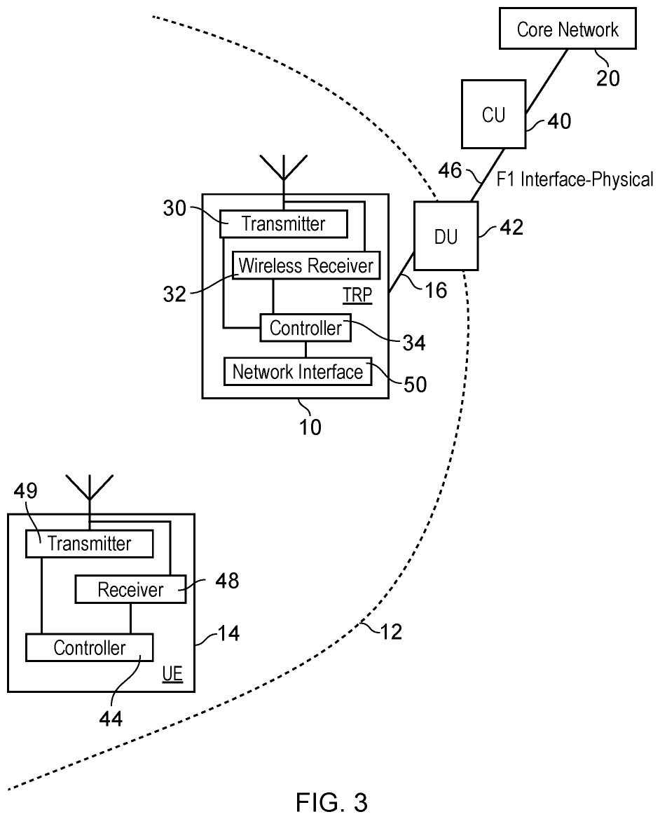

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

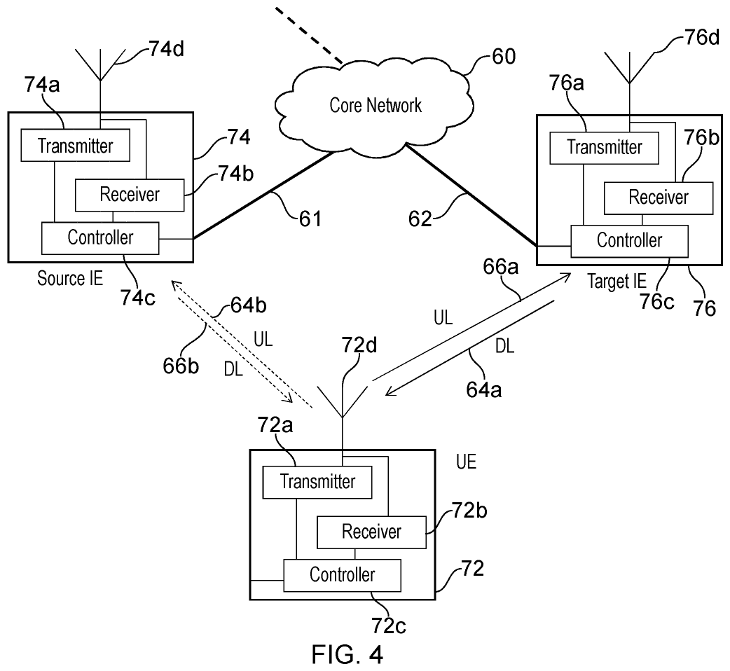

A detailed illustration of a wireless communications network in which a handover (HO) may be performed is shown in FIG. 4. As will be appreciated from FIG. 4, a communications device 72 is handed over from a source infrastructure equipment 74 to a target infrastructure equipment 76 forming part of a radio access network to a core network 60. As will be appreciated the communications device 72 is an example of a communications device such as the communications device 14 of FIGS. 1, 2 and 3. The communications device 72 may be a UE in one example.

Before the handover, the communications device 72 transmits signals on an uplink UL and receive signals on a downlink DL from a source infrastructure equipment 74. The source infrastructure equipment 74 and the target infrastructure equipment 76 may each be thought of as a gNB 1 as shown in FIG. 1 or a combination of a controlling node 40 and TRP 10 as shown in FIGS. 2 and 3. Before the handover, the communications device 72 is shown to transmit uplink data to the source infrastructure equipment 74 via uplink resources UL of a wireless access interface as illustrated generally by dashed arrow 64b to the source infrastructure equipment 74. The communications device 72 may similarly be configured to receive downlink data transmitted by the source infrastructure equipment 74 via downlink resources DL as indicated by dashed arrow 66b from the source infrastructure equipment 74 to the communications device 72. After the handover, the communications device 72 is shown to transmit uplink data to the target infrastructure equipment 76 via uplink resources UL of a wireless access interface as illustrated generally by solid arrow 66a to the target infrastructure equipment 76. The communications device 72 may similarly be configured to receive downlink data transmitted by the target infrastructure equipment 76 via downlink resources DL as indicated by solid arrow 64a from the target infrastructure equipment 76 to the communications device 72.

In FIG. 4, the source and target infrastructure equipment 74, 76 are each connected to a core network 60 via interfaces 61, 62 to a controller 74c, 76c of the respective infrastructure equipment 74 and 76. The source and target infrastructure equipment 74, 76 each include a receiver 74b, 76b connected to an antenna 74d, 76d and a transmitter 74a, 76a connected to the antenna 74d, 76d. Correspondingly, the communications device 72 includes a controller 72c connected to a receiver 72b which receives signals from an antenna 72d and a transmitter 72a also connected to the antenna 72d.

The controllers 74c, 76c are configured to control the source and target infrastructure equipment 74, 76 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 74c, 76c may comprise circuitry which is suitably configured/programmed to provide the desired functionality using conventional programming/configuration techniques for equipment in wireless telecommunications systems. The transmitters 74a, 76a and the receivers 74b, 76b may comprise signal processing and radio frequency filters, amplifiers and circuitry in accordance with conventional arrangements. The transmitters 74a, 76a the receivers 74b, 76b and the controllers 74c, 76c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 74 will in general comprise various other elements associated with its operating functionality.

Correspondingly, the controller 72c of the communications device 72 is configured to control the transmitter 72a and the receiver 72b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 72c may comprise circuitry which is suitably configured/programmed to provide the desired functionality using conventional programming/configuration techniques for equipment in wireless telecommunications systems. Likewise, the transmitter 72a and the receiver 72b may comprise signal processing and radio frequency filters, amplifiers and circuitry in accordance with conventional arrangements. The transmitters 72a, receivers 72b, and controllers 72c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 72 will in general comprise various other elements associated with its operating functionality, for example a power source, user interface, and so forth, but these are not shown in FIG. 4 in the interests of simplicity.

The controllers 74c, 72c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

In wireless telecommunications networks, such as LTE and NR type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel and so the procedure is commonly referred to as a RACH or PRACH procedure/process. As those skilled in the art would understand, typical RACH procedures may comprise either four steps (which are referred to as msg1, msg2, msg3, and msg4) or two steps (which are referred to as msgA and msgB).

### 6G Wireless Communications and Sustainability in Telecommunications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IIoT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful. Doing so would allow such mobile terminals to operate not only more efficiently, but also in a more sustainable manner, with less power being wasted.

Sustainability is an increasingly important topic for 6G, and mobile network operators, network vendors, and mobile phone/other user equipment manufacturers are increasingly focussing on their carbon footprint. Seventeen goals for sustainable development have been identified by the United Nations [3], which are:
No poverty;
Zero hunger;
Good health and well-being;
Quality education;
Gender equality;
Clean water and sanitation;
Affordable and clean energy;
Decent work and economic growth;
Industry, innovation, and infrastructure;
Reduced inequalities;
Sustainable cities and communities;
Responsible consumption and production;
Climate action;
Life below water;
Life on land;
Peace, justice, and strong institutions; and
Partnerships for the goals.

There are a few use cases of mobile networks which are already known and are helping achieve some of these sustainability targets. For example, such sustainability targets being addressed by mobile networks may include no poverty (by raising awareness), zero hunger (through smart agriculture), good health (mobile health), quality education (remote and immersive learning), clean water and sanitation (smart cities), and industry innovation (services such as URLLC). However, the role of mobile networks in helping achieve some others of the above listed sustainability targets—such as affordable and clean energy, sustainable cities and communities, climate action, and life on Earth—are more questionable.

Mobile networks consume a considerable amount of energy in terms of their worldwide deployment. RAN networks particularly are the leaders in terms of energy consumption in current (i.e. mainly 4G) mobile network deployments. This is due to the deployment of all of the RAN equipment (such as base stations) in the field, as opposed to the more centralised deployment of core network apparatus. At the same time, mobile networks are handling higher and higher amounts of data generated by an ever increasing number of data hungry users, and hence the overall data usage is growing every month. With new radio access technologies like 5G and 6G, new services and use-cases requiring always-on data applications such as digital twin, XR, gaming, and the metaverse are proposed. Another development for 5G and beyond is that the spectrum used for the communication of data is a higher frequency spectrum (e.g. higher frequencies than used for previous generations of wireless communications networks), resulting in smaller cell sizes. All of these factors contribute to the necessary deployment of a greater amount of RAN equipment in order to meet ever increasing data and coverage/capacity requirements. These requirements go against the above-mentioned sustainability targets described in [3], and thus present a challenge for wireless network operators, network vendors, and mobile phone manufacturers in the overall effort to achieve these sustainability goals.

### Sustainability Profiles

In the process of handing over a communications device, from, for example, a first cell to a second cell, information may be exchanged between the communications device and the wireless communications network so that the core network or the application server can adjust to the new environment of the communications device. In other words, a handover procedure relating to the handing over of a UE from a source cell to a target cell, which may be served respectively by a source infrastructure equipment and a target infrastructure equipment, may require transmission of information between the communications device and the core network. It should be noted that the handover of a communications device is from one serving infrastructure equipment to another infrastructure equipment, and one example of this is where the communications device moves from one cell to another, although this disclosure is not limited to the transition from one cell to another. For instance, in a RAN that operates without forming cells, the present disclosure may be implemented by a system wherein the serving infrastructure equipment changes for a communications device, without changing cells. In this breaking of connection and reformation of connection between the communications device and the wireless communications network, it is envisaged that there may be an opportunity to configure the system in line with the abovementioned sustainability goals. The present technique relates to this opportunity, and further details are given below.

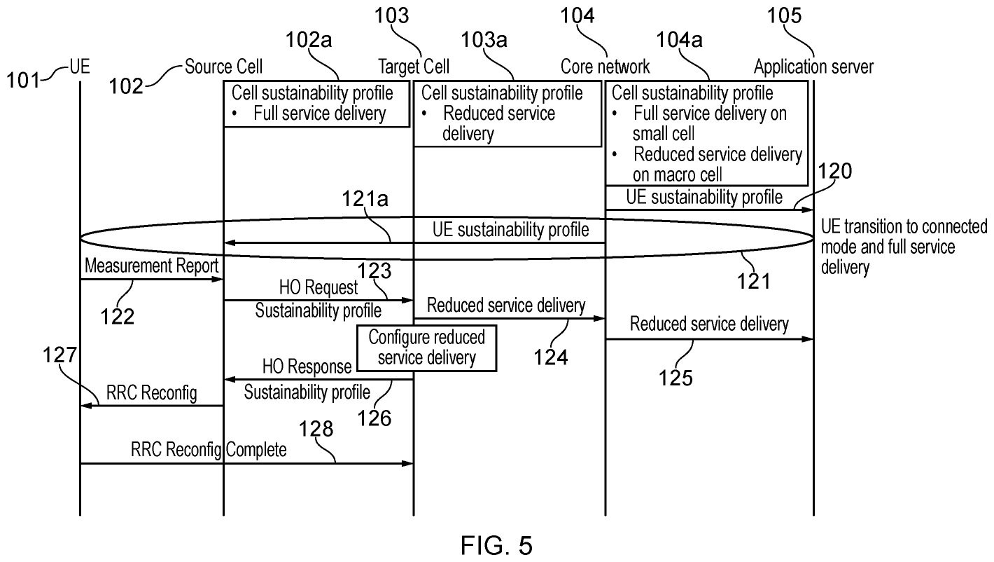

FIG. 5 shows a message flow diagram representation of a first wireless communications system comprising a communications device 101, a first infrastructure equipment, or a source cell, 102, a second infrastructure equipment, or target cell, 103, a core network 104, and an application server 105 in accordance with at least some embodiments of the present technique. The communications device 101 is configured to transmit signals to and/or receive signals from the wireless communications network (e.g. to/from the first infrastructure equipment serving source cell 102 and/or second infrastructure equipment serving target cell 103). Specifically, the communications device 101 may be configured to transmit data to and/or receive data from the wireless communications network (e.g. to/from the first infrastructure equipment serving source cell 102 and/or second infrastructure equipment serving target cell 103) via a wireless access interface provided by the wireless communications network (e.g. the Uu interface between the communications device 101 and the Radio Access Network (RAN), which includes the first infrastructure equipment serving source cell 102 and/or second infrastructure equipment serving target cell 103).

Following an agreement between a user of a communications device such as 101 and a service provider, for instance a network operator who may operate the core network 104 and infrastructure equipment serving cells, the service provider may create a sustainability profile for a user. In a particular example as demonstrated in the following Figure, the user is a sensitive user who may be in agreement with a reduction in service in order to increase a sustainability of the operation of the network. The profile, for instance user sustainability profile, may be created in the user subscription profile in an element of the core network such as a home subscriber service (HSS) or user device management (UDM). In other words, a user may agree with a service provider, e.g. network operator, in advance to receive either a full or a reduced service delivery from the network, depending on how sustainable a delivery of the service is. Alternatively, the profile may be created between a user and the application layer, e.g. application server.

In the example of FIG. 5, a cell is associated with a sustainability profile in addition to a user sustainability profile. For example, the source cell 102 in FIG. 1 has a sustainability profile indicating that it is configured to provide delivery of a full service to communications devices such as communications device 101. This could be per service provided to the communications device, i.e. per communications device in a cell, or the cell sustainability profile may be per cell. In other words, as shown in the example of FIG. 5, the source cell 102, and the target cell 103 have cell sustainability profiles associated with them. Specifically, cell sustainability profile 102a is associated with the source cell 102, and cell sustainability profile 103a is associated with the target cell 103. In particular, source cell sustainability profile 102a is an indication that the source cell supports full service delivery for a communications device in the source cell, and target cell sustainability profile 103a is an indication that the target cell supports a reduced service delivery for a communications device in the target cell. For example, the resolution of video (e.g. 4K->HD) and/or refresh rate (e.g. 120 frame per second to 30 frame per second) is reduced to save the radio resources. The sustainability profile is mainly related to sustainability target like power consumption. However, it may not be necessarily related to the sustainability target. For example, latency of backhaul link may depend on cell/base station. Latency mainly depends on the type of backhaul (optical fiber, mmWave, satellite and so on), which is connected to the cell/base station. If the latency is high, UE may select whether it accepts either the reduced service with high latency or gave up the service based on cell sustainability profile.

Core network 104 also contains an indication of a cell sustainability profile for at least one cell that the core network is connected to and this may be created and/or updated either by the RAN node or by the core network when the RAN node establishes the connection with the core network. In this example, cell sustainability profile 104a is an indication that the core network supports a full service delivery on a small cell, such as for example source cell 102, and an indication that the core network supports a reduced service delivery on a macro cell such as for example target cell 103.

In a first step 120, the core network 104 transmits to the application server 105 a UE sustainability profile. This may be achieved via any appropriate wired or wireless connection as the skilled person would implement a network side of the present disclosure. It is envisaged in a second step 121, that the communications device transitions from, for example, an idle mode to a connected mode, or resumes a service from an inactive mode that it has previously been in. As part of this step, the UE sustainability profile is transmitted from the core network 104 to the source cell 102 by a transmission 121a. Alternatively, it may be stored in the communications device context for an inactive state. As will be appreciated from the above discussion of the cell sustainability profile, the source cell supplies to a communications device a full service. At the conclusion of the second step 121, the communications device is in an active mode e.g. RRC_CONNECTED, and configured to transmit and receive signals in the source cell according to a full service. Based on the UE sustainability profile and a received set of Quality of Service/Quality of Experience, QoS/QoE, parameters for a Packet Data Unit, PDU, session received from the core network 104, the source cell 102 and accompanying infrastructure equipment may set up resources for this communications device 101. In this way, a user operating a communications device consumes a service in line with sustainability credentials and an agreed sustainability profile.

At a third step 122, the communications device 101 triggers a handover procedure by initiating a measurement report to be sent to the network. In other words, the communications device sends a measurement report to the source cell 102 infrastructure equipment, which forms part of the network. This may be performed by the communications device 101 when the communications device 101 moves outside of a coverage of the cell it is in, namely the source cell. In other example embodiments, the communications device 101 may trigger this measurement report transmission when the quality of signal received at the communications device 101 drops below a predetermined threshold. For example, a quality of signal in this situation may be synonymous with a reference signal received power, RSRP, or reference signal received quality, RSRQ. In other examples, the quality of signal might be associated with a signal to noise ratio, SNR, measured at the communications device for downlink communications, and measured at the infrastructure equipment for uplink communications. Alternatively, other measures of a signal quality may be employed by the skilled person, in line with their general technical knowledge. In addition, signals that the quality of signal is associated with may be control signals or signals representing data, or may be reference signals transmitted specifically for the purpose of making measurements, for example measurements of RSRP, RSRQ, or SNR. The source cell may determine a handover target cell 103 and send a handover request message to the cell in a following step 123. In this step, the source cell 102 may include in the transmission a sustainability profile associated with the communications device 101 and the user, and/or it may include service information in order to inform the target cell.

In response to this transition, and based on its own sustainability profile, the target cell 103 may decide to configure a reduced bandwidth for the same service. In this case, as will be appreciated, the application layer 105 must also reduce the rate of data to be transmitted to the communications device 101. There are a plurality of options for how an indication of this reduction in data rate should be communicated to the application layer 105.

One possible option is that the target cell 103 sends an indication of the reduction in data rate to be transmitted to the communications device 101 to the application layer, or application server, 105.

Another possible option is that the application layer 105 keeps track of different buffering levels in the communications device 101 and the network 104 in order to reduce the rate. In other words, the application layer may request at particular periodicity updates of an amount of data held in data buffers at the communications device 101 and the network 104. It may then compare these two buffer data amounts, and if the amount of data held in a buffer at the network 104 exceeds the amount of data held in a buffer at the communications device 101 by a predetermined amount, or if the difference in data amounts held by the buffers changes by a predetermined amount in a set amount of time, the application layer 105 may reduce the rate of data to be sent to the communications device 101 in order to equalise the amount of data held in the two buffers. This may indicate that the communications device 101 is receiving a reduced bit rate from the network 104 via a relevant infrastructure equipment, either due to experiencing poor coverage from its infrastructure equipment, for example due to interference or some other impediment, or because of its sustainability profile and/or sustainability credentials. FIG. 5 shows a representation of the first possible option, where the target cell 103 indicates to the application layer 105 that the data rate transmitted to the communications device 101 will be reduced.

Likewise, there are a plurality of options as to when the application layer 105 is informed of a change in the data rate to be transmitted to the communications device 101. The target cell 103 may indicate this change to the core network 104 after determining the reduction in data rate for the communications device. This may be before or after sending to the infrastructure equipment serving the source cell 102, in other words to a serving node 102, a handover request acknowledgement message. The core network 104 would then send this indication to the application layer 105, which may then modify the QoS flow or PDU session with new parameters reflecting a reduced service delivery mode.

Alternatively, the Radio Access Network, that is the target cell 103, may notify the application layer 105 directly (e.g. not via the core network) via appropriate signalling. For example, the target cell 103 may use a user plane packet to inform the application layer 105 of the reduction in data rate to be transmitted to the communications device 101, in an analogous way to the use of an Explicit Congestion Notification, ECN, in an IP packet to inform the application layer of congestion, whereby new bits may be needed in IP header, greater detail of existing ECN procedure is provided in the annex. In other example embodiments, the application layer 105 may be informed via control plane signalling like a voice/video codec rate adaptation. See annex for further details and discussion of this rate adaptation. This voice/video codec rate adaptation may be performed if, for example, radio conditions for the communications device are not good i.e. below a certain threshold, or if the Radio Access Network is congested. An infrastructure equipment, such as that which serves the target cell 103, may send an uplink/downlink rate to the communications device 101 using a Media Access Control, MAC, Control Element, MAC-CE.

The communications device 101 may also request a rate adaptation with a MAC-CE to be transmitted to the wireless communications network. Following a transmission of the MAC-CE, the communications device 101 may start a prohibit timer, that is a timer within the period of which the communications device 101 is not permitted to send another MAC-CE to the wireless communications device to adapt the rate of data to be transmitted to the communications device 101. In other embodiments where data is transmitted from another communications device to the communications device 101, the communications device 101 may send a rate change request to the other communications device using a multimedia telephony, MMTEL, application. Further and better details are provided on MMTEL applications in the annex.

Continuing the description of FIG. 5, the target cell 103 transmits to the core network 104 an explicit indication of a determined reduction in data rate to be transmitted to the communications device 101. It performs this transmission of an explicit indication in a fifth step 124, and thereby informs the core network of a reduced service delivery to be provided to the communications device 101. Following this, the core network forwards this indication to the application layer, i.e. application server, 105 in a sixth step 125.

Having informed the application layer 105 of the reduced service delivery to be provided to the communications device 101, and thus having configured the reduced service delivery for the communications device 101 for the wireless communications network side, the target cell 103 transmits in step 126 to the source cell 102 a handover response, in response to the handover request transmitted from the source cell 102 to the target cell 103 in step 123. With this response message, the target cell 103 may include in the message a sustainability profile associated with the target cell 103, as this may indicate to the source cell 102 a reduction in the service to be provided to the communications device 101.

Following this, in step 127, the source cell 102 transmits to the communications device 101 a Radio Resource Control Reconfiguration, RRC Reconfig, message. This indicates to the communications device 101 a handover that has been arranged for it from the source cell 102 to the target cell 103. The method concludes in step 128 by the communications device 101 transmitting to the target cell 103 infrastructure equipment an indication that the handover has been completed, by transmitting a Radio Resource Control Reconfiguration Complete, RRC Reconfig Complete, signal. In this way, a handover from a source cell to a target cell may be performed by a communications device, and a sustainability profile related to the communications device and/or the target cell may be considered, and may influence the adaptation of the service delivered to the communications device.

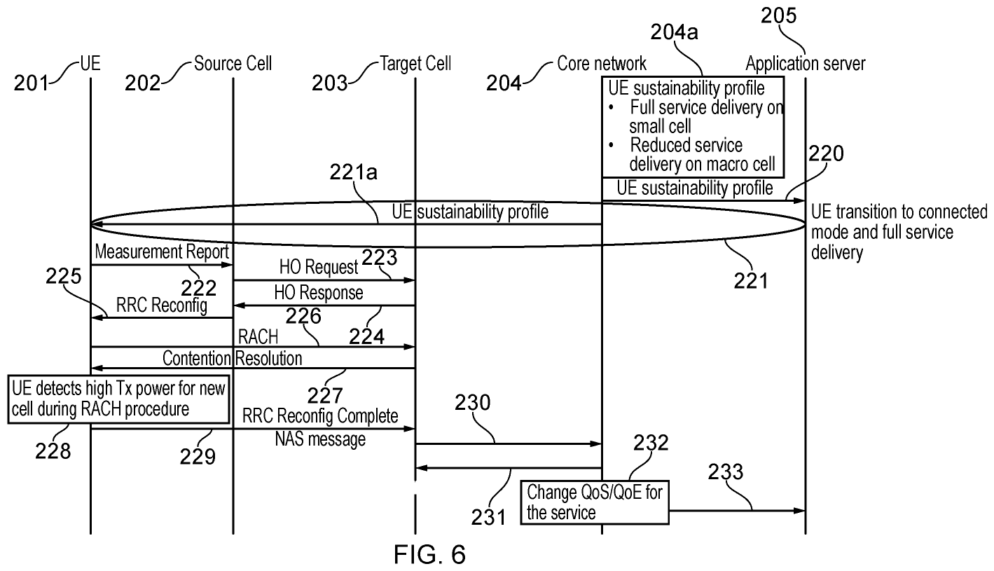

In another example embodiment, as shown in FIG. 6, a Radio Access Network cell is not involved in the handover in the same way, and the communications device and/or the User interacts with the core network for switching between sustainability profiles. In this case, the communications device determines a sustainability profile relating to the communications device based on a number of factors, including for example its transmission power (e.g. higher transmission power might be associated with a less sustainable sustainability profile) and the number of retransmissions with the cell (e.g. a greater number of retransmissions required for a message to be successfully received by the cell might be associated with a less sustainable sustainability profile). Having determined the sustainability profile related to the communications device, the communications device may inform the core network, for example via Non Access Stratum signalling, about the determined sustainability profile. During an initial connection process, this information may be included in a service request message, or may be signalled to the core network via some other appropriate method, such as dedicated signalling for that purpose.

For handover and establishing a connection with a target cell, a communications device may determine at approximately the same time as the communications device performs random access channel, RACH, procedure whether the communications device will change the sustainability profile. If an outcome of the determination is that the communications device changes the sustainability profile, then the communications device may include an indication related to this in an embedded NAS message to the core network in RRC Reconfiguration Complete message or a separate NAS message. If an outcome of the determination is that the communications device will not change the sustainability profile, then no further signalling may be required. For a communications device that is connecting to a cell of the wireless access network, having previously been in an inactive mode, that is when a connection between the communications device and the relevant serving infrastructure equipment is not actively transmitting and receiving signals, but the RRC is not completely released, an indication related to a change in sustainability profile may alternatively be included in an RRC Resume Complete message.

In particular, with reference to FIG. 6, an embodiment of the present techniques is depicted in a message flow diagram thereof. Analogously to FIG. 5, a communications device or user equipment UE, 201, a source cell 202, a target cell 203, a core network 204, and an application server, or application layer, 205 are depicted. The core network 204 has a communications device, UE, sustainability profile 204a associated with it, which specifies that a full service may be delivered to the communications device 201 on a small cell, for instance on a cell such as the source cell 202, and a reduced service may be delivered to the communications device 201 on a macro cell, that is a cell larger than some predetermined threshold, such as for example the target cell 203.

In a first step 220, the core network 204 transmits to the application server 205 an indication of the communications device sustainability profile 204a that it has stored. This allows the application layer 205 to be informed of the rate of data that may be sent to the communications device 201 depending on the cell that it is connected to, e.g. whether it is connected to the source cell 202 or the target cell 203.

In a second step 221, the communications device 201 transitions into a connected mode with the source cell 202. Since the communications device sustainability profile 204a indicates that full service delivery is available when on a small cell, such as the source cell 202, this transition to a connected mode also involves a full service being delivered to the communications device 201. This step involves the transmission 221a of the communications device sustainability profile 204a from the core network 204 to the communications device 201.

In a third step 222, the communications device 201 triggers a handover procedure by initiating a measurement report to be sent to the network. In other words, the communications device sends a measurement report to the source cell 202 infrastructure equipment, which forms part of the network. This is performed when a predetermined condition is met, such as, for example, the communications device 201 moving more than a set distance from an infrastructure equipment serving the communications device, moving outside of a coverage of a cell the communications device is in, namely the source cell 202, when a quality of signal (e.g. RSRP, RSRQ or SNR) is reduced below a predetermined threshold where this threshold could be set to a higher value for sustainability aware UE compared to a normal UE, or if a number of retransmissions of a signal to/from a serving infrastructure equipment such as that providing source cell 202 exceeds a predetermined number. This number could relate to HARQ retransmissions or RLC retransmissions for RLC-AM mode. This list of conditions is intended to be exemplary, and not limiting of the events which may cause a communications device such as UE 201 to transmit a measurement report. The skilled person would understand that other scenarios triggering the transmission of a measurement report are conceivable, and that this disclosure is intended to cover these scenarios also.

In a fourth step 223, the source cell 202 transmits a handover request to the target cell. Unlike in the example illustrated by FIG. 5, this example handover request may not be accompanied by a transmission of the communications device sustainability profile 204a.

In a fifth step 224, the target cell 203 responds to the source cell 202 by transmitting to it an indication of a handover response. This may be a confirmation of the handover procedure requested by the source cell in step 223. Then, the source cell 202 transmits to the communications device 201 an indication of a handover, for example in the form of a RRC Reconfig message. This provides information to the communications device 201 related to the target cell 203, which the communications device requires to send signals to and/or receive signals from an infrastructure equipment serving target cell 203.

With this information related to the target cell 203, the communications device 201 in step 226 performs a RACH procedure with respect to the target cell 203 and in step 227 receives a contention resolution message in response from the infrastructure equipment serving the target cell 203.

The communications device 201 may monitor the transmission power and other parameters such as the number of retransmissions required for connection with the target cell 203, and at step 228 detects that the transmission power required for transmission of signals as part of the RACH procedure is above a predetermined threshold. Responsive to this, the communications device 201 may then transmit 229 a NAS message to the infrastructure equipment serving the target cell 203, comprising an RRC Reconfig Complete message. A level of power for transmissions to the target cell, or a number of retransmissions required for successful communication, may be contrary to the communications device sustainability profile 204a, and thus the target cell, on receipt of the RRC Reconfig Complete message, forward the NAS message transparently to the core network and core network may determine that a service provided to the communications device 201 is to be amended.

This may be performed via a determination at the core network 204 and be transmitted to the application layer 205. However, in FIG. 6, an alternative is illustrated where, on receiving the RRC Reconfig Complete message as part of step 229, the target cell 203 sends 230 an indication of parameters related to the transmission of signals forming the connection between the communications device 201 and the target cell 203 to the core network 204. Having received information related to the connection between the target cell 203 and the communications device, and having stored an indication of the communications device sustainability profile 204a, the core network 204 may determine 232 that a quality of service, QoS, or a quality of experience, QoE, related to the service provided to the communications device are to be changed. If it determines that the QoS/QoE for the service are to be changed, the core network 204 may then inform 233 the application server 205 of the change to be made, so that the application layer can implement this change with respect to data sent to the communications device via the infrastructure equipment serving the target cell 203.

Those skilled in the art would appreciate that the methods shown by FIGS. 5 and 6 may be adapted in accordance with embodiments of the present technique. For example, other intermediate steps may be included in these methods, or the steps may be performed in any logical order. Though embodiments of the present technique have been described largely by way of the example communications system shown in FIGS. 5 and 6, it would be clear to those skilled in the art that they could be equally applied to other systems to those described herein.

### Sustainability Profile Modification

The process of establishing and implementing a sustainability profile for a UE has been described above. In some implementations the sustainability profile may be static for a UE i.e. once the operator and the user have agreed to a particular sustainable service delivery policy, the sustainable service delivery policy will remain constant throughout the duration of the service and/or throughout a particular connection or PDU session.

However, in certain situations, there may be a desire to modify the sustainability profile for the UE. This may occur for a variety of reasons. For example, a user may have agreed a reduced service delivery (i.e. a more sustainability-aware service deliver), however the current QoS/QoE of this service delivery may be found not to meet requirements. In such a case, a user my not be satisfied by a current QoS/QoE of the reduced service delivery and may wish to change to full-service delivery for a particular time or for the current connection, in order to improve QoS/QoE. Conversely, a user may be enjoying full-service delivery but may wish to opt for a more sustainability-aware service. This, for example, might be based on a battery level of the UE being low or a user may have knowledge that a particular reduced service delivery provides acceptable QoS/QoE under certain conditions. In another example, a user may wish to opt for full-service delivery when using a combination of WLAN and 3GPP technologies (e.g. LTE/NR/5G/6G networks), but revert to a reduced service delivery if WLAN is disabled or unavailable and vice versa.

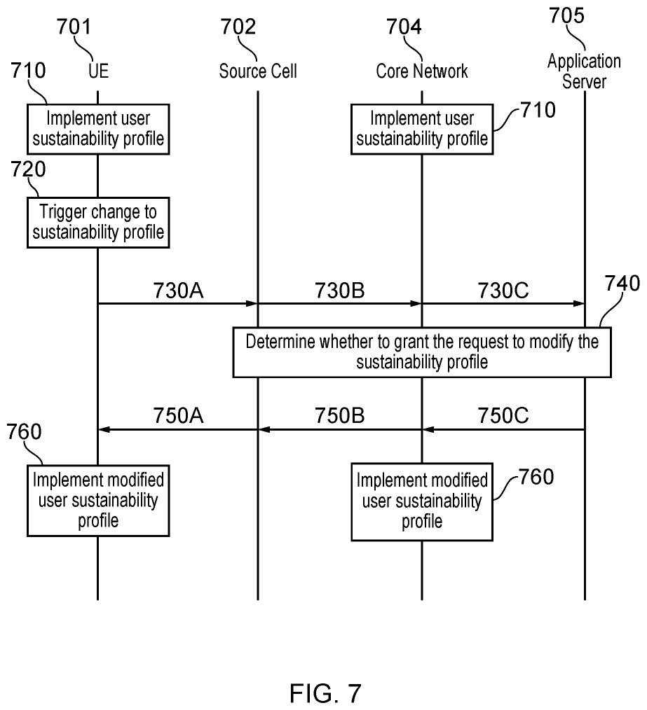

Accordingly, the techniques of this disclosure allow a sustainability profile for a UE to be modified. A UE may do this at substantially any time by informing the RAN, core network (CN) and/or application layers. An example of this process is shown in FIG. 7, where a UE 701 may communicate with a core network 704, where this communication is carried out according to a sustainability profile 701. This sustainability profile may have been established in substantially any manner, such as the techniques described above in the present disclosure.

At some time, the UE 701 may determine 720 that its sustainability profile should be modified. The UE 701 may make this determination 720 for a number of different reasons. For example, the determination 720 to modify the sustainability profile may be based on a condition of the UE 701 itself (e.g. the battery level of the UE 701 falling below or rising above a predetermined threshold), a user selection (i.e. a user input via a user interface), or a coverage condition for the UE 701 (e.g. the UE 701 entering or exiting an area of WLAN coverage, a quality of connection provided by a network gNB, the UE 701 entering a particular cell or network coverage area), however the change in sustainability profile may be triggered by substantially any means. Additionally, or alternatively, the determination 720 may be based on a number of retransmissions of a signal to the UE 701 device from the source cell 702, and/or a number of retransmissions of a signal to the source cell 702 from the UE 701, for example determining whether said number of retransmissions is above a predetermined threshold. This signal could relate to HARQ retransmissions or RLC retransmissions for RLC-AM mode. This list of conditions is intended to be exemplary, and not limiting of the events which may cause a communications device such as UE 701 to transmit a request 730. The skilled person would understand that other scenarios triggering the transmission of a measurement report are conceivable, and that this disclosure is intended to cover these scenarios also.

Upon determining 720 that the UE's 701 sustainability profile should be modified, the UE 701 may transmit a request 730 to modify its sustainability profile. This request 730 may be transmitted 730A to a source cell 702, which may in turn transmit 730B this request (or a separate request to modify the sustainability profile) to the core network (i.e. a core network part), which may in turn transmit 730C this request (or a separate request to modify the sustainability profile) to an application server. The request 730 may be transmitted by the UE 701 in any number of ways. For example, the UE 701 may transmit a new uplink control information in the physical layer, transmit a new MAC-CE or add/modify a field in a MAC header in the MAC layer, transmit a radio link control (RLC) control PDU or add/modify a field of an RLC header in the RLC layer, transmit a packet data convergence protocol (PDCP) PDU or add/modify a field of a PDCP header in the PDCP layer, transmit a new RRC or NAS message in the RRC and/or NAS layer, and/or use application layer signalling. The request may indicate new values for parameters of the modified sustainability profile, or may indicate a particular sustainability profile of a predetermined list of sustainability profiles, or may indicate a desired increase or decrease in one or more parameters of the existing sustainability profile.

An application programming interface (API) may be provided that facilitates modifying a UE's sustainability profile based on a user preference. For example, the UE may provide an API when a user requesting a modification to its sustainability profile. Alternatively, or additionally, network may provide an API to the application layer for changing the user sustainability profile. The API may, for example, be provided by an operating system of the UE.

UEs may operate in a number of different operational modes, for example an RRC connected mode, an RRC inactive mode, and an RRC idle mode. When operating in an RRC connected mode, a UE may be able to transmit the request 730 to change the UE's sustainability profile. A UE operating in an RRC inactive or an RRC idle mode may listen to or listen for periodic paging or wake-up signals (WUS). The paging duration or the wake-up time may be based on the sustainability profile. That is, the sustainability profile may indicate paging discontinuous reception (DRX) parameters and/or RAN DRX parameters, as well as any relaxation of measurements and/or monitoring requirements of paging/WUS for users.

When operating in an RRC inactive or an RRC idle mode, a UE may in some cases transition to an RRC connected mode in order to transmit the request 730 to change the UE's sustainability profile. Furthermore, when operating in an RRC inactive mode, a UE may transmit the request 730 to change the UE's sustainability profile as part of an RRC resume procedure. This process may be used, for example, by UEs in an RRC inactive mode with SDT capability and may be performed by informing the RAN, CN, and or application layer.

Upon receiving the request 730 to change the UE's sustainability profile the network may determine 740 whether to grant the UE's request to modify the sustainability profile and may transmit a response 750 to the UE 701. That is, the network may either accept or reject the UE's request. This determination of whether to accept or reject the UE's request 730 may be made at the source cell 702 (i.e. at the infrastructure equipment providing the source cell 702), the core network 704, and/or the application server 705. That is, the source cell 702 may itself determine 740 that the request 730 is to be accepted or rejected (for example based on a level of congestion in the RAN), or the source cell 702 may determine 740 that the request 730 is accepted or rejected based on receiving an indication from the core network 704. The source cell 702 may then transmit to the UE 701 a response 750A to the request 730. Similarly, the core network 704 may itself determine 740 that the request 730 is to be accepted or rejected, or the core network 704 may determine 740 that the request 730 is accepted or rejected based on receiving an indication from the application server 705. The core network 704 may then transmit to the source cell 702 a response 750B to the request 730. Furthermore, the application server 705 may itself determine 740 that the request 730 is to be accepted or rejected and may transmit a response 750C to the core network 704.

In some examples, if the source cell 702, core network 704, or application server 705 determine that the request 730 to change the UE's sustainability profile should be rejected, a response 750 may not be transmitted to the UE 701, thereby reducing network signalling or not exposing network policies for a response. For example, the application server 705 may not transmit a response 750C, the core network 704 may not transmit a response 750B, and/or the source cell 702 may not transmit a response 750A. Accordingly, the UE 701 may determine that the request 730 has been rejected based on not receiving a response 750 within a predetermined time period after the request 730 was transmitted. Similarly, the source cell 702 may determine that the request 730 has been rejected based on not receiving a response from the core network 704 or application server 705 within a predetermined time period after the request 730 was transmitted, and/or the core network 704 may determine that the request 730 has been rejected based on not receiving a response from the application server 705 within a predetermined time period after the request 730 was transmitted. In other words, the source cell 702, core network part 703, and/or application server may selectively issue a response 750 based on whether the request 730 should be accepted or rejected.

Furthermore, while FIG. 7 depicts the application server 705 as receiving the request 730C and transmitting the response 750C from the same core network 704 entity this may not be the case in all examples. In particular, in some examples, the application server 705 may in some cases receive the request directly from the source cell 702 or a different RAN node (i.e. without the request being sent via the core network 704). The application server may then issue a response to a different entity (e.g. a different cell or a different RAN node). Furthermore, in some examples the application server 705 may receive the request directly from the source cell 702 or a different RAN node, and may issue a response to the core network 704. The core network may, for example, authenticate the response before the response is transmitted to the source cell 702 or UE 701.

In some cases, the request is not propagated to the application server 705 or the core network 704 and a decision to reject the request may be determined by the source cell 702. Alternatively, in some examples, the core network 704 may decide to reject the request. Furthermore, in some examples, the source cell 702 may receive an indication from the core network 704 that the request 730 should be accepted. However, the source cell 702 may independently determine that the request 730 should be rejected (for example due to RAN congestion). Accordingly, the source cell 702 may determine that the indication 750B from the core network 704 should be ignored and therefore reject the request 730.

The decision 740 by the network to accept or reject the request 730 may be based on a number of different factors. As one example, the network may determine whether to grant the request 730 based on a level of congestion in the network. For instance, the network may determine that a level of congestion in the network is above a predetermined threshold and therefore that a request to change the UE's sustainability profile to provide an increased service level (i.e. improved service delivery) should be rejected. Conversely, the network may determine that a level of congestion in the network is below a predetermined threshold and therefore that a request to change the UE's sustainability profile to provide a reduced service level (i.e. reduced service delivery) should be accepted. Any rejection of a request to modify the sustainability may not always be visible to the end user of UE 701, as UEs are generally not aware of the level of congestion in the network or how networks manage their radio resources.

The decision 740 by the network to accept or reject 730 may additionally or alternatively be based on a type of traffic transmitted between the UE 701 and the network, and/or any policy requirements. For example, a UE 701 may be required to keep its camera active for a particular duration (e.g. due to transmissions of video traffic, or due to a policy requirement) and as such a request to modify the UE's 701 sustainability profile to reduce the service delivery for UE 701 may be rejected.

If the network decides to accept the request 730, the response 750 transmitted to the UE 701 indicates that the request 730 is accepted. Accordingly, the modified sustainability profile may be stored and implemented 760 by the UE 701 and the network. For example, the modified sustainability profile may be stored at the application server 705, the core network 704, and/or the source cell 702, and these entities may operate in accordance with the modified sustainability profile.

For example, the network may modify the periodicity of timing of paging/WUS transmitted to/for the UE 701 according to the modified sustainability profile. Additionally or alternatively, the network (e.g. the source cell 702) may configure a reduced or increased bandwidth or bit rate for the UE 701 according to the modified sustainability profile. In this manner, it is possible for a UE 701 to modify its own existing sustainability profile, however the network has the final decision as to whether the modification request should be granted.

If the network rejects the request by the UE 701 to change the sustainability profile, the UE 701 may in some cases transmit a new request (or retransmit the same request) to change the sustainability profile for the UE 701. For example, if the initial request was rejected due to network congestion, the new request at a later time may be accepted if the level of congestion in the network has reduced. However, mechanisms may be employed to prevent the UE 701 from continually transmitting new requests to update the sustainability profile. For example, the UE 701 may implement a retransmission timer, whereby the UE 701 is only allowed to submit a new request after a certain period of time has elapsed since the initial request was transmitted. The length of such a retransmission timer may vary and in some cases could be infinite, such that the UE 701 is only allowed to transmit a request to change its sustainability profile once (e.g. within a single session). Additionally or alternatively, the UE 701 may only be allowed to transmit a set number of sustainability profile change requests within a predetermined time period.

Moreover, in some examples, the network may determine that the sustainability profile for a UE should be modified without the UE sending a request to the network at all. That is, the source cell, core network, or application server may determine that the sustainability profile for the UE should be modified, as described above, but without the UE sending a request to the network. The source cell, core network, or application server may then operate in a similar manner to when a request from a UE is accepted in order to change the sustainability profile, as described above. For example, the source cell, core network, and/or application server may transmit a notification (i.e. an indication) to the UE that the UE's sustainability profile is modified (i.e. is to be modified).

Such determination by the network may be made based on a variety of factors, including those described above, such as a level of congestion in the network (e.g. the RAN network), a type of traffic transmitted between a UE and the network, policy requirements, a number of retransmissions between a UE and a cell, however this list is not intended to be limiting.

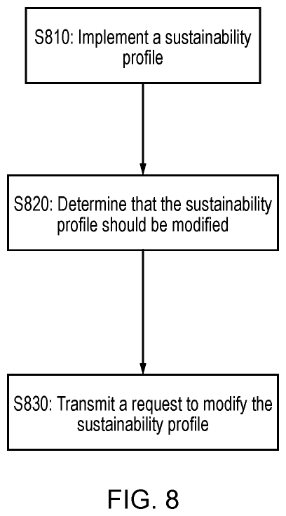

FIG. 8 illustrates a flow diagram of a method of operating a communications device according to an example of the present disclosure. The communications device is configured to transmit signals to and/or receive signals from an infrastructure equipment via a wireless access interface provided by a wireless communications network, the wireless communications network comprising at least the infrastructure equipment. The method begins at step S810 where the communications device implements a sustainability profile for the communications device. In other words, the communications device operates in accordance with the sustainability profile. In order to implement the sustainability profile, the communications device may have received an indication of the sustainability profile from a network entity, such as an infrastructure equipment.

At step S820, the communications device determines that the sustainability profile for the communications device should be modified. This may be based on a number of factors as described above. The method then proceeds to step S830 where the communications device transmits, to the infrastructure equipment, a request to modify the sustainability profile. The communications device may transmit the request to the same infrastructure equipment that provided the initial indication of the sustainability profile, or may transmit the request to a different infrastructure equipment.

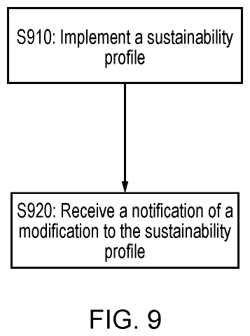

FIG. 9 illustrates a flow diagram of a method of operating a communications device according to an example of the present disclosure. The communications device is configured to transmit signals to and/or receive signals from an infrastructure equipment via a wireless access interface provided by a wireless communications network, the wireless communications network comprising at least the infrastructure equipment. The method begins at step S910 where the communications device implements a sustainability profile for the communications device. In other words, the communications device operates in accordance with the sustainability profile. In order to implement the sustainability profile, the communications device may have received an indication of the sustainability profile from a network entity, such as an infrastructure equipment.

At step S920, the communications device receives, from the infrastructure equipment, a notification of a modification to the sustainability profile. The notification may be received from the infrastructure equipment without the communications device transmitting a request to the network for a modification to the sustainability profile.

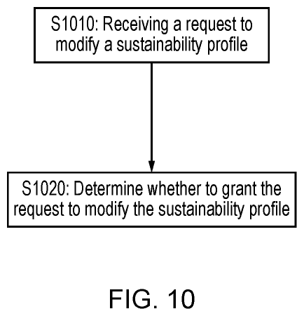

FIG. 10 illustrates a flow diagram of a method of operating an infrastructure equipment according to an example of the present disclosure. The infrastructure equipment is configured to transmit signals to and/or receive signals from a communication device via a wireless access interface provided by a wireless communications network, the wireless communications network comprising at least the infrastructure equipment. The method begins at step S1010 where the infrastructure equipment receives a request from the communications device to modify the sustainability profile for the communications device. At step S1020, the infrastructure equipment then determines whether to grant the modification request. In some cases, the infrastructure equipment may send a response to the request to the communications device (e.g. if the request is granted).

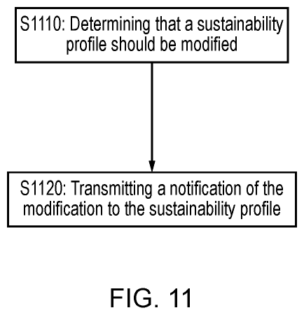

FIG. 11 illustrates a flow diagram of a method of operating an infrastructure equipment according to an example of the present disclosure. The infrastructure equipment is configured to transmit signals to and/or receive signals from a communication device via a wireless access interface provided by a wireless communications network, the wireless communications network comprising at least the infrastructure equipment. The method begins at step S1110 where the infrastructure equipment determines that a sustainability profile for the communications device should be modified. The infrastructure equipment may determine that the sustainability profile should be modified without having received a request for modification of the sustainability profile from the communications device. For example, the infrastructure equipment may itself determine that the sustainability profile should be modified (e.g. based on RAN congestion), or may determine that the sustainability profile should be modified based on receiving a notification from an application server or a core network part. The method may then proceed to step S1120 where the infrastructure equipment transmits a notification of the modification of the sustainability profile to the communications device.

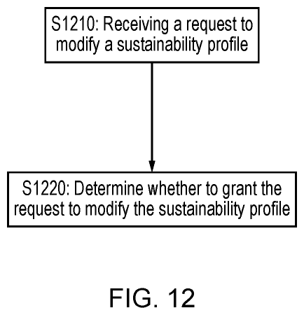

FIG. 12 illustrates a flow diagram of a method of operating a core network part according to an example of the present disclosure. The core network part is configured to transmit signals to and/or receive signals from an infrastructure equipment in the wireless communications network. The method begins at step S1210 where the core network part receives a request from the infrastructure equipment to modify a sustainability profile for a communications device. At step S1220, the core network part then determines whether to grant the modification request. In some cases, the core network part may send a response to the request to the infrastructure equipment.

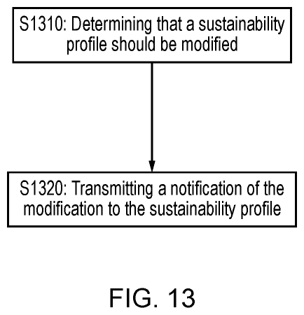

FIG. 13 illustrates a flow diagram of a method of operating a core network part according to an example of the present disclosure. The core network part is configured to transmit signals to and/or receive signals from an infrastructure equipment in the wireless communications network. The method begins at step S1310 where the core network part determines that a sustainability profile for a communications device should be modified. The core network part may determine that the sustainability profile should be modified without having received a request for modification of the sustainability profile from the communications device or an infrastructure equipment in communication with the communications device. For example, the core network part may itself determine that the sustainability profile should be modified, or may determine that the sustainability profile should be modified based on receiving a notification from an application server. The method may then proceed to step S1320 where the core network part transmits a notification of the modification of the sustainability profile to the infrastructure equipment or communications device.

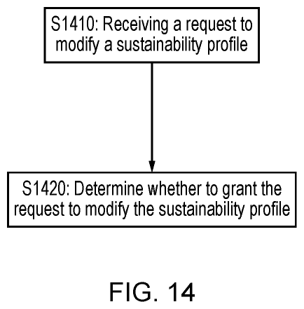

FIG. 14 illustrates a flow diagram of a method of operating an application server according to an example of the present disclosure. The application server is configured to be communicable with one or more infrastructure equipment of a wireless communications network. The infrastructure equipment may be a core network part or an infrastructure equipment that is configured to communicate with a communications device via a wireless interface. The method begins at step S1410 where the application server receives a request from the infrastructure equipment to modify a sustainability profile for a communications device. At step S1420, the application server then determines whether to grant the modification request. In some cases, the core network part may send a response to the request to the infrastructure equipment.

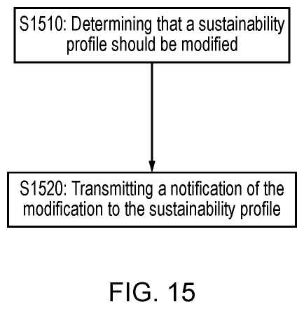

FIG. 15 illustrates a flow diagram of a method of operating an application server according to an example of the present disclosure. The application server is configured to be communicable with one or more infrastructure equipment of a wireless communications network. The infrastructure equipment may be a core network part or an infrastructure equipment that is configured to communicate with a communications device via a wireless interface. The method begins at step S1510 where the application server determines that a sustainability profile for a communications device should be modified. The application server may determine that the sustainability profile should be modified without having received a request for modification of the sustainability profile from the communications device the infrastructure equipment. For example, the infrastructure equipment may itself determine that the sustainability profile should be modified. The method may then proceed to step S1520 where the application server transmits a notification of the modification of the sustainability profile to the infrastructure equipment.

Accordingly, from one perspective there has been described methods, apparatus and circuitry for modifying and requesting modifications to a sustainability profiles for a communication device. The sustainability profile includes radio resource control parameters to be implemented by the communications device for communication with an infrastructure equipment of a wireless communication network. A communications device may request a modification to an existing sustainability profile, which may be accepted or rejected by the network. The network may also determine that the sustainability profile should be modified without the communications device requesting such a modification.

### ANNEX

### Explicit Congestion Notification

The infrastructure equipment and the communications device support of an Explicit Congestion Notification is specified in clause 5 of [4], the entirety of which is incorporated by reference.

### Support for MMTEL Voice and Video Enhancements

### RAN-Assisted Codec Adaptation

RAN-assisted codec adaptation provides a means for an infrastructure, such as an eNB, to send a codec adaptation indication, that may include a recommended bit rate, to assist the UE to select or adapt to a codec rate for MMTEL voice or MMTEL video. The RAN-assisted codec adaptation mechanism supports an uplink/downlink bit rate increase or decrease. For a bearer associated with configuration of MBR greater than GBR, the recommended uplink/downlink bit rate is within boundaries set by the MBR and GBR of the concerned bearer.

For uplink or downlink bit rate adaptation, an eNB may send a recommended bit rate to the UE to inform the UE of the currently recommended transport bit rate on the local uplink or downlink, which the UE may use in combination with other information to adapt the bit rate, e.g. the UE may send a bit rate request to a peer UE via application layer messages as specified in TS 26.114 [5], the entirety of which is incorporated herein by reference, which the peer UE may use in combination with other information to adapt the codec bit rate. The recommended bit rate may be in kbps at the physical layer at the time when the decision is made.

The recommended bit rate for UL and DL may be conveyed as a MAC Control Element (CE) from the infrastructure equipment to the communications device as outlined in FIG. 8. FIG. 8 essentially shows a transmission 150 of a signal representing a recommendation of an uplink, or alternatively of a downlink, bit rate. This signal is transmitted from an infrastructure equipment, represented by eNB 151 and received by a communications device, represented by UE 152.

Based on the recommended bit rate from the infrastructure equipment, a communications device such as the UE may initiate an end-to-end bit rate adaptation with its peer (UE or MGW). The UE may also send a query message to its local infrastructure equipment to check if a bit rate recommended by its peer can be provided by the infrastructure equipment. The UE is not expected to go beyond the recommended bit rate from the eNB.

The recommended bit rate query message is conveyed as a MAC Control Element (CE) from the UE to the eNB as outlined in FIG. 9. Essentially, FIG. 9 shows a depiction of a signal 250 transmitted from a communications device represented by UE 252 and received at an infrastructure equipment represented by eNB 251. This signal represents data, and when received by the infrastructure equipment, provides a query as to the uplink, or alternatively as to the downlink, bit rate recommendation for transmission between the communications device and the infrastructure equipment.

A prohibit timer can be configured for each logical channel by the wireless communications network to limit communications devices such as the UE from sending frequent query MAC CEs. Independent prohibit timers are used for each direction (uplink and downlink) to prohibit the UE from retransmitting exactly the same query MAC CE to the infrastructure equipment during the configured time.

### MMTEL Signalling Optimisation

In case of network congestion (e.g. maximum number of users that can be connected, poor radio conditions, etc), an operator may want to prioritize MMTEL voice/MMTEL video access. For both type of accesses, the MO voice call cause value is used. During the re-direction procedure, if the UE receives the RRC Connection Release message with redirection and the voice call is ongoing, the UE keeps the call in the application layer. After the UE re-accesses the network, the voice GBR bearer can be recovered immediately.

### MMTEL Voice Quality/Coverage Enhancements

In order to enhance the voice quality and coverage, the techniques for PUSCH coverage enhancement introduced in Rel-13 for Control Element, CE, Mode A can be configured also for communications devices in non-CE mode. These techniques are applied in a new PUSCH enhancement mode and include:
PUSCH subframe repetition with intra-bundle or inter-bundle frequency hopping and
UL asynchronous HARQ operation.

The PUSCH enhancement mode can be enabled only on PCell. In the PUSCH enhancement mode, the PUSCH maximum bandwidth is 20 MHz. The transition of the communications device between a normal mode and a PUSCH enhancement mode is controlled and triggered by RRC signalling. As part of the transition procedure, the UL HARQ operation switches between synchronous (normal mode) and asynchronous (PUSCH enhancement mode), with a partial MAC reset.

PUSCH coverage enhancement may require that an air interface delay budget be relaxed to increase the robustness of the transmission. Such relaxation may be achieved when a UE in good coverage indicates a preference to the infrastructure equipment to reduce the local air interface delay by sending a UEAssistanceInformation message with delayBudgetReport set to type1 to decrease the DRX cycle length, so that the E2E delay and jitter can be reduced. A peer UE in bad coverage can send a UEAssistanceInformation message with delayBudgetReport set to type2 to its eNB to indicate a preference on Uu air interface delay adjustments, see TS 36.331 [6], TS 36.211 [7], and TS 36.213 [8], the entirety of each document being incorporated herein by reference. Based on the UE report and other information, the E-UTRAN may configure the UE with coverage enhancement techniques. When the UE detects changes such as end-to-end MMTEL voice quality or local radio quality, the UE may inform the eNB its new preference by sending UEAssistanceInformation messages with updated contents.

The following numbered paragraphs provide further example aspects and features of the present technique:
1. A method of operating a communications device configured to transmit signals to and/or receive signals from an infrastructure equipment via a wireless access interface provided by a wireless communications network, the wireless communications network comprising at least the infrastructure equipment, the method comprising:
   receiving an indication of a sustainability profile to be implemented by the communications device for communication with an infrastructure equipment, wherein the sustainability profile includes radio resource control parameters to be implemented by the communications device for communication with the infrastructure equipment;
   determining that the sustainability profile for the communications device should be modified;
   transmitting, to the infrastructure equipment, a request to modify the sustainability profile for the communications device.
2. The method according to clause 1, further comprising:
   based on determining that a response to the request to modify the sustainability profile for the communications device has not been received by the communications device within a predetermined time period, determining that the request is rejected.
3. The method according to clause 1, further comprising:
   receiving, from the infrastructure equipment, a response to the request to modify the sustainability profile.
4. The method according to clause 3, wherein the response indicates that the request to modify the sustainability profile is accepted.
5. The method according to clause 4, further comprising:
   in response to receiving the response indicating that the request to modify the sustainability profile is accepted, communicating with the infrastructure equipment according to the modified sustainability profile.
6. The method according to clause 3, wherein the response indicates that the request to modify the sustainability profile is rejected.
7. The method according to clause 1, 2, 3 or 6, wherein the request is a first request, and wherein the method further comprises:
   based on determining that the request to modify the sustainability profile is rejected, determining whether to transmit a second request to modify the sustainability profile.
8. The method according to clause 7, wherein the communications device determines whether to transmit the second request based on:
   whether a number of requests, transmitted by the communications device, to change the sustainability profile within a predetermined time period is below a predetermined limit, and/or
   whether an elapsed time since the transmission of the first request is above a predetermined threshold.
9. The method according to any preceding clause, wherein the communications device determines that the sustainability for the communications device should be modified based on a user input via a user interface.
10. The method according to any preceding clause, wherein the communications device determines that the sustainability for the communications device should be modified based on a condition of the communication device.
11. The method according to clause 10, wherein the condition of the communication device includes one or more of: a battery level of the communication device, the communications device entering a coverage area of a new cell, a level of coverage provided by the infrastructure equipment, and/or a connectivity status of the communications device.
12. The method according to clause 10 or 11, wherein the condition of the communication device includes a change in radio conditions, a number of retransmissions of a signal to the communications device from the infrastructure equipment, and/or a number of retransmissions of a signal to the infrastructure equipment from the communications device.
13. The method according to any preceding clause, wherein the communications device is in an idle mode of operation or an inactive mode of operation prior to transmitting the request to modify the sustainability profile for the communications device.
14. The method according to any preceding, further comprising:
   based on determining that the sustainability for the communications device should be modified, transitioning from an idle mode of operation or an inactive mode of operation to a connected mode of operation, prior to transmitting the request to modify the sustainability profile; and
   in response to receiving the response to the request to modify the sustainability profile, transitioning from the connected mode of operation to the idle mode of operation or the inactive mode of operation.
15. The method according to clause 14, comprising:
   transitioning from the inactive mode of operation to the connected mode of operation during a radio resource control resume procedure.
16. The method according to any preceding clause, wherein the communications device is configured to determine, based on the sustainability policy, one or more timing parameters for monitoring for a paging signal and/or wake-up signal when the communications device.
17. The method according to any preceding clause, wherein the sustainability policy is indicative of one or more timing parameters for paging signals and/or wake-up signals transmitted by the infrastructure equipment.
18. The method according to any preceding clause, wherein the request to modify the sustainability profile is issued according to an application programming interface, API, provided by the infrastructure equipment or an application server.
19. A communications device comprising:
   a transceiver configured to transmit signals to and/or to receive signals from an infrastructure equipment of a wireless communications network via a wireless radio interface provided by the wireless communications network, and
   a controller configured in combination with the transceiver to:
      receive an indication of a sustainability profile to be implemented by the communications device for communication with an infrastructure equipment, wherein the sustainability profile includes radio resource control parameters to be implemented by the communications device for communication with the infrastructure equipment;
      determine that the sustainability profile for the communications device should be modified;
      transmit, to the infrastructure equipment, a request to modify the sustainability profile for the communications device.
20. Circuitry for a communications device, the circuitry comprising:
   transceiver circuitry configured to transmit signals to and/or to receive signals from an infrastructure equipment of a wireless communications network via a wireless radio interface provided by the wireless communications network, and
   controller circuitry configured in combination with the transceiver circuitry to:
      receive an indication of a sustainability profile to be implemented by the communications device for communication with an infrastructure equipment, wherein the sustainability profile includes radio resource control parameters to be implemented by the communications device for communication with the infrastructure equipment;
      determine that the sustainability profile for the communications device should be modified;
      transmit, to the infrastructure equipment, a request to modify the sustainability profile for the communications device.
21. A method of operating a communications device configured to transmit signals to and/or receive signals from an infrastructure equipment via a wireless access interface provided by a wireless communications network, the wireless communications network comprising at least the infrastructure equipment, the method comprising:
   receiving an indication of a sustainability profile to be implemented by the communications device for communication with an infrastructure equipment, wherein the sustainability profile includes radio resource control parameters to be implemented by the communications device for communication with the infrastructure equipment; and
   receiving, from the infrastructure equipment, a notification of a modification to the sustainability profile.
22. A communications device comprising:
   a transceiver configured to transmit signals to and/or to receive signals from an infrastructure equipment of a wireless communications network via a wireless radio interface provided by the wireless communications network, and
   a controller configured in combination with the transceiver to:
      receive an indication of a sustainability profile to be implemented by the communications device for communication with an infrastructure equipment, wherein the sustainability profile includes radio resource control parameters to be implemented by the communications device for communication with the infrastructure equipment; and
      receive, from the infrastructure equipment, a notification of a modification to the sustainability profile.
23. Circuitry for a communications device, the circuitry comprising:
   transceiver circuitry configured to transmit signals to and/or to receive signals from an infrastructure equipment of a wireless communications network via a wireless radio interface provided by the wireless communications network, and
   controller circuitry configured in combination with the transceiver circuitry to:
      receive an indication of a sustainability profile to be implemented by the communications device for communication with an infrastructure equipment, wherein the sustainability profile includes radio resource control parameters to be implemented by the communications device for communication with the infrastructure equipment; and
      receive, from the infrastructure equipment, a notification of a modification to the sustainability profile.
24. A method of operating an infrastructure equipment configured to transmit signals to and/or receive signals from a communication device via a wireless access interface provided by a wireless communications network, the wireless communications network comprising at least the infrastructure equipment, the method comprising:
   receiving, from the communications device, a request to modify a sustainability profile for the communications device, wherein the sustainability profile includes radio resource control parameters to be implemented by the communications device for communication with the infrastructure equipment;
   determining whether the request to modify the sustainability profile should be granted.
25. The method according to clause 24, further comprising:
   transmitting, to a core network part, the request to modify the sustainability profile.
26. The method according to clause 25, further comprising:
   receiving, from the core network part, an indication of whether the request to modify the sustainability profile is accepted;
   wherein the infrastructure equipment determines whether the request to modify the sustainability profile should be granted according to the received indication of whether the request to modify the sustainability profile is accepted.
27. The method according to clause 25, wherein the infrastructure equipment determines that the request is rejected based on determining that the infrastructure equipment has not received a response to the request within a predetermined time period.
28. The method according to clause 25, further comprising:
   receiving, from the core network part, an indication of whether the request to modify the sustainability profile is to be accepted; and
   determining that the indication from the core network should be ignored and that the request to modify the sustainability profile should be rejected.
29. The method according to any of clauses 24-26, wherein the infrastructure equipment determines that the request to modify the sustainability profile should be accepted. and wherein the infrastructure equipment transmits, to the communications device, a response to the request to modify the sustainability profile indicating that the request is accepted.
30. The method according to clause 29, further comprising:
   based on determining that the sustainability profile should be granted, modifying one or more timing parameters for paging signals and/or wake-up signals transmitted by the infrastructure equipment; and
   transmitting paging signals and/or wake-up signals according to the modified timing parameters.
31. The method according to any of clauses 24-28, wherein the infrastructure equipment determines that the request to modify the sustainability profile should be rejected.
32. The method according to clause 31, wherein the infrastructure equipment transmits, to the communications device, a response to the request to modify the sustainability profile indicating that the request is rejected.
33. The method according to any of clauses 24-32, wherein the infrastructure equipment provides an application programming interface, API, for issuing the request to modify the sustainability profile.
34. An infrastructure equipment comprising:
   a transceiver configured to transmit signals to and/or to receive signals from a communications device via a wireless radio interface provided by the infrastructure equipment, and
   a controller configured in combination with the transceiver to:
      receive, from the communications device, a request to modify a sustainability profile for the communications device, wherein the sustainability profile includes radio resource control parameters to be implemented by the communications device for communication with the infrastructure equipment;
      determine whether the request to modify the sustainability profile should be granted.
35. Circuitry for an infrastructure equipment, the circuitry comprising:
   transceiver circuitry configured to transmit signals to and/or to receive signals from a communications device via a wireless radio interface provided by the infrastructure equipment, and
   controller circuitry configured in combination with the transceiver circuitry to:
      receive, from the communications device, a request to modify a sustainability profile for the communications device, wherein the sustainability profile includes radio resource control parameters to be implemented by the communications device for communication with the infrastructure equipment;
      determine whether the request to modify the sustainability profile should be granted.
36. A method of operating an infrastructure equipment configured to transmit signals to and/or receive signals from a communication device via a wireless access interface provided by a wireless communications network, the wireless communications network comprising at least the infrastructure equipment, the method comprising:
   determining that a sustainability profile for the communications device should be modified, wherein the sustainability profile includes radio resource control parameters to be implemented by the communications device for communication with the infrastructure equipment; and
   transmitting, to the communications device, a notification of the modification to the sustainability profile.
37. An infrastructure equipment comprising:
   a transceiver configured to transmit signals to and/or to receive signals from a communications device via a wireless radio interface provided by the infrastructure equipment, and
   a controller configured in combination with the transceiver to:
      determine that a sustainability profile for the communications device should be modified, wherein the sustainability profile includes radio resource control parameters to be implemented by the communications device for communication with the infrastructure equipment; and
      transmit, to the communications device, a notification of the modification to the sustainability profile.
38. Circuitry for an infrastructure equipment, the circuitry comprising:
   transceiver circuitry configured to transmit signals to and/or to receive signals from a communications device via a wireless radio interface provided by the infrastructure equipment, and
   controller circuitry configured in combination with the transceiver circuitry to:
      determine that a sustainability profile for the communications device should be modified, wherein the sustainability profile includes radio resource control parameters to be implemented by the communications device for communication with the infrastructure equipment; and
      transmit, to the communications device, a notification of the modification to the sustainability profile.
39. A method of operating a core network part of a wireless communications network, the core network part configured to transmit signals to and/or receive signals from an infrastructure equipment in the wireless communications network, the method comprising:
   receiving, from the infrastructure equipment, a request to modify a sustainability profile for a communications device, wherein the sustainability profile includes radio resource control parameters to be implemented by the communications device for communication with the infrastructure equipment;
   determining whether the request to modify the sustainability profile should be granted.
40. The method according to clause 39, further comprising:
   transmitting, to an application server, the request to modify the sustainability profile.
41. The method according to clause 40, further comprising:
   receiving, from the application server, an indication of whether the request to modify the sustainability profile is accepted;
   wherein the core network part determines whether the request to modify the sustainability profile should be granted according to the received indication of whether the request to modify the sustainability profile is accepted.
42. The method according to clause 40, wherein the core network part determines that the request is rejected based on determining that the core network part has not received, from the application server, a response to the request within a predetermined time period.
43. The method according to clause 40, further comprising:
   receiving, from the application server, an indication of whether the request to modify the sustainability profile is to be accepted; and
   determining that the indication from the application server should be ignored and that the request to modify the sustainability profile should be rejected.
44. The method according to any of clauses 39-42, wherein the core network part determines that the request to modify the sustainability profile should be accepted.
45. The method according to any of clauses 39-43, wherein the core network part determines that the request to modify the sustainability profile should be rejected.
46. The method according to any of clauses 39-45, further comprising:
transmitting, to the infrastructure equipment, a response to the request to modify the sustainability profile, wherein the response indicates whether the request is accepted or rejected.
47. The method according to any of clauses 39-46, wherein the core network part determines whether the request to modify the sustainability profile should be granted based a type of traffic transmitted to the communications device on the wireless communications network.
48. The method according to any of clauses 39-47, wherein request to modify the sustainability profile is received from the communications device and via the infrastructure equipment.
49. A core network part comprising:
   a transceiver configured to transmit signals to and/or to receive signals from an infrastructure equipment via a communications interface provided by the core network part, and
   a controller configured in combination with the transceiver to:
      receive, from the infrastructure equipment, a request to modify a sustainability profile for a communications device, wherein the sustainability profile includes radio resource control parameters to be implemented by the communications device for communication with the infrastructure equipment;
      determine whether the request to modify the sustainability profile should be granted.
50. Circuitry for a core network part comprising:
   transceiver circuitry configured to transmit signals to and/or to receive signals from an infrastructure equipment via a communications interface provided by the core network part, and
   controller circuitry configured in combination with the transceiver circuitry to:
      receive, from the infrastructure equipment, a request to modify a sustainability profile for a communications device, wherein the sustainability profile includes radio resource control parameters to be implemented by the communications device for communication with the infrastructure equipment;
      determine whether the request to modify the sustainability profile should be granted.
51. A method of operating a core network part for a wireless communications network, the core network part configured to transmit signals to and/or receive signals from an infrastructure equipment in the wireless communications network, the method comprising:
   determining that a sustainability profile for the communications device should be modified, wherein the sustainability profile includes radio resource control parameters to be implemented by the communications device for communication with the infrastructure equipment; and
   transmitting, to the infrastructure equipment, a notification of the modification to the sustainability profile.
52. A core network part comprising:
   a transceiver configured to transmit signals to and/or to receive signals from an infrastructure equipment for a wireless communications network via a communications interface provided by the core network part, and
   a controller configured in combination with the transceiver to:
      determine that a sustainability profile for the communications device should be modified, wherein the sustainability profile includes radio resource control parameters to be implemented by the communications device for communication with the infrastructure equipment; and
      transmit, to the infrastructure equipment, a notification of the modification to the sustainability profile.
53. Circuitry for a core network part comprising:
   transceiver circuitry configured to transmit signals to and/or to receive signals from an infrastructure equipment for a wireless communications network via a communications interface provided by the core network part, and
   controller circuitry configured in combination with the transceiver circuitry to:
      determine that a sustainability profile for the communications device should be modified, wherein the sustainability profile includes radio resource control parameters to be implemented by the communications device for communication with the infrastructure equipment; and
      transmit, to the infrastructure equipment, a notification of the modification to the sustainability profile.
54. A method of operating an application server, the application server configured to be communicable with one or more infrastructure equipment of a wireless communications network, the method comprising:
   receiving, from a first infrastructure equipment of the one or more infrastructure equipment, a request to modify a sustainability profile for a communications device, wherein the sustainability profile includes radio resource control parameters to be implemented by the communications device for communication with an infrastructure equipment of the wireless communications network;
   determining whether the request to modify the sustainability profile should be granted.
55. The method according to clause 54, wherein the application server determines that the request to modify the sustainability profile should be accepted.
56. The method according to clause 54, wherein the application server determines that the request to modify the sustainability profile should be rejected.
57. The method of any of clauses 54-56, further comprising:
   transmitting, to a second infrastructure equipment of the one or more infrastructure equipment, a response to the request to modify the sustainability profile, wherein the response indicates whether the request is accepted or rejected.
58. The method according to clause 57, wherein the first infrastructure equipment and the second infrastructure equipment are the same infrastructure equipment.
59. The method according to clause 57 or 58, wherein the first and/or second infrastructure equipment are a core network part of the wireless communications network.
60. The method according to any of clauses 54-59, wherein the application server determines whether the request to modify the sustainability profile should be granted based a type of traffic transmitted to the communications device on the wireless communications network.
61. The method according to any of clauses 54-60, wherein the application server provides an application programming interface, API, for issuing the request to modify the sustainability profile.
62. An application server comprising:
   a transceiver configured to transmit signals to and/or to receive signals from an infrastructure equipment for a wireless communications network via a communications interface provided by the application server, and
   a controller configured in combination with the transceiver to:
      receive, from a first infrastructure equipment of the one or more infrastructure equipment, a request to modify a sustainability profile for a communications device, wherein the sustainability profile includes radio resource control parameters to be implemented by the communications device for communication with an infrastructure equipment of the wireless communications network;
      determine whether the request to modify the sustainability profile should be granted.
63. Circuitry for an application server comprising:
   transceiver circuitry configured to transmit signals to and/or to receive signals from an infrastructure equipment for a wireless communications network via a communications interface provided by the application server, and
   controller circuitry configured in combination with the transceiver to:
      receive, from a first infrastructure equipment of the one or more infrastructure equipment, a request to modify a sustainability profile for a communications device, wherein the sustainability profile includes radio resource control parameters to be implemented by the communications device for communication with an infrastructure equipment of the wireless communications network;
      determine whether the request to modify the sustainability profile should be granted.
64. A method of operating an application server, the application server configured to be communicable with one or more infrastructure equipment of a wireless communications network, the method comprising:
   determining that a sustainability profile for a communications device should be modified, wherein the sustainability profile includes radio resource control parameters to be implemented by the communications device for communication with the infrastructure equipment; and
   transmitting, to an infrastructure equipment, a notification of the modification to the sustainability profile.
65. An application server comprising:
   a transceiver configured to transmit signals to and/or to receive signals from an infrastructure equipment for a wireless communications network via a communications interface provided by the application server, and
   a controller configured in combination with the transceiver to:
      determine that a sustainability profile for a communications device should be modified, wherein the sustainability profile includes radio resource control parameters to be implemented by the communications device for communication with the infrastructure equipment; and
      transmit, to an infrastructure equipment, a notification of the modification to the sustainability profile.
66. Circuitry for an application server comprising:
   transceiver circuitry configured to transmit signals to and/or to receive signals from an infrastructure equipment for a wireless communications network via a communications interface provided by the application server, and
   controller circuitry configured in combination with the transceiver to:
      determine that a sustainability profile for a communications device should be modified, wherein the sustainability profile includes radio resource control parameters to be implemented by the communications device for communication with the infrastructure equipment; and
      transmit, to an infrastructure equipment, a notification of the modification to the sustainability profile.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units.

As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] United Nations, “Sustainable Development Goals”, [Online], Available at: https://sdgs.un.org/goals.
[4] IETF RFC 3168 (September 2001): “The Addition of Explicit Congestion Notification (ECN) to IP”.
[5] TS 26.114 “IP Multimedia Subsystem (IMS); Multimedia Telephony; Media handling and interaction (Release 7)”, 3^{rd} Generation Partnership Project, v7.4.0, March 2008.
[6] TS 36.331 “Radio Resource Control (RRC); Protocol specification (Release 10)”, 3^{rd} Generation Partnership Project, v10.13.0, June 2014.
[7] TS 36.211 “Physical Channels and Modulation (Release 10)”, 3^{rd} Generation partnership Project, v10.4.0, December 2011
[8] TS 36.213 “Physical layer procedures (Release 12)”, 3^{rd} Generation Partnership Project, v12.8.0, December 2015.

1. A method of operating a communications device configured to transmit signals to and/or receive signals from an infrastructure equipment via a wireless access interface provided by a wireless communications network, the wireless communications network comprising at least the infrastructure equipment, the method comprising:
receiving an indication of a sustainability profile to be implemented by the communications device for communication with an infrastructure equipment, wherein the sustainability profile includes radio resource control parameters to be implemented by the communications device for communication with the infrastructure equipment;
determining that the sustainability profile for the communications device should be modified;
transmitting, to the infrastructure equipment, a request to modify the sustainability profile for the communications device.

2. The method according to claim 1, further comprising:
based on determining that a response to the request to modify the sustainability profile for the communications device has not been received by the communications device within a predetermined time period, determining that the request is rejected.

3. The method according to claim 1, further comprising:
receiving, from the infrastructure equipment, a response to the request to modify the sustainability profile.

4. The method according to claim 3, wherein the response indicates that the request to modify the sustainability profile is accepted.

5. The method according to claim 4, further comprising:
in response to receiving the response indicating that the request to modify the sustainability profile is accepted, communicating with the infrastructure equipment according to the modified sustainability profile.

6. The method according to claim 3, wherein the response indicates that the request to modify the sustainability profile is rejected.

7. The method according to claim 1, wherein the request is a first request, and wherein the method further comprises:
based on determining that the request to modify the sustainability profile is rejected, determining whether to transmit a second request to modify the sustainability profile.

8. The method according to claim 7, wherein the communications device determines whether to transmit the second request based on:
whether a number of requests, transmitted by the communications device, to change the sustainability profile within a predetermined time period is below a predetermined limit, and/or
whether an elapsed time since the transmission of the first request is above a predetermined threshold.

9. The method according to claim 1, wherein the communications device determines that the sustainability for the communications device should be modified based on a user input via a user interface.

10. The method according to claim 1, wherein the communications device determines that the sustainability for the communications device should be modified based on a condition of the communication device.

11. The method according to claim 10, wherein the condition of the communication device includes one or more of: a battery level of the communication device, the communications device entering a coverage area of a new cell, a level of coverage provided by the infrastructure equipment, and/or a connectivity status of the communications device.

12. The method according to claim 10, wherein the condition of the communication device includes a change in radio conditions, a number of retransmissions of a signal to the communications device from the infrastructure equipment, and/or a number of retransmissions of a signal to the infrastructure equipment from the communications device.

13. The method according to claim 1, wherein the communications device is in an idle mode of operation or an inactive mode of operation prior to transmitting the request to modify the sustainability profile for the communications device.

14. The method according to claim 1, further comprising:
based on determining that the sustainability for the communications device should be modified, transitioning from an idle mode of operation or an inactive mode of operation to a connected mode of operation, prior to transmitting the request to modify the sustainability profile; and
in response to receiving the response to the request to modify the sustainability profile, transitioning from the connected mode of operation to the idle mode of operation or the inactive mode of operation.

15. The method according to claim 14, comprising:
transitioning from the inactive mode of operation to the connected mode of operation during a radio resource control resume procedure.

16. The method according to claim 1, wherein the communications device is configured to determine, based on the sustainability policy, one or more timing parameters for monitoring for a paging signal and/or wake-up signal when the communications device.

17. The method according to claim 1, wherein the sustainability policy is indicative of one or more timing parameters for paging signals and/or wake-up signals transmitted by the infrastructure equipment.

18. The method according to claim 1, wherein the request to modify the sustainability profile is issued according to an application programming interface, API, provided by the infrastructure equipment or an application server.

19. A communications device comprising:
a transceiver configured to transmit signals to and/or to receive signals from an infrastructure equipment of a wireless communications network via a wireless radio interface provided by the wireless communications network, and
a controller configured in combination with the transceiver to:
receive an indication of a sustainability profile to be implemented by the communications device for communication with an infrastructure equipment, wherein the sustainability profile includes radio resource control parameters to be implemented by the communications device for communication with the infrastructure equipment;
determine that the sustainability profile for the communications device should be modified;
transmit, to the infrastructure equipment, a request to modify the sustainability profile for the communications device.

20.-33. (canceled)

34. An infrastructure equipment comprising:
a transceiver configured to transmit signals to and/or to receive signals from a communications device via a wireless radio interface provided by the infrastructure equipment, and
a controller configured in combination with the transceiver to:
receive, from the communications device, a request to modify a sustainability profile for the communications device, wherein the sustainability profile includes radio resource control parameters to be implemented by the communications device for communication with the infrastructure equipment;
determine whether the request to modify the sustainability profile should be granted.

35.-66. (canceled)
